(19) United States
(12) Patent Application Publication
(10) Pub. No.: US 2008/0010976 A1
(43) Pub. Date: Jan. 17, 2008

(54) Exhaust Gas Regenerator Comprising a Catalyst

(76) Inventor: Werner Lohberg, Paderborn (DE)

Correspondence Address: BROWDY AND NEIMARK, P.L.L.C.;624 NINTH STREET, NW, SUITE 300, WASHINGTON, DC, 20001-5303, US

(21) Appl. No.: 10/586,600

(22) PCT Filed: Jan. 15, 2005
(86) PCT No.: PCT/EP05/00359

§ 371 Date: Aug. 14, 2007

(30) Foreign Application Priority Data
Jan. 20, 2004 (DE) 10 2004-002 7420

(51) Int. Cl. F02M 25/07

(52) U.S. Cl. 60/278

(57) ABSTRACT

The invention relates to an exhaust gas regenerator (VG) comprising an exhaust gas catalyst (KAT). According to the invention, the hot-operated catalyst (KAT) is located adjacent to a diffusion membrane (MEM) that is resistant to high temperatures and is, in turn, adjacent to a regenerated gas collector (RS) that is maintained at a lower pressure (pr) than the respectively prevailing inner pressure (pk) in the catalyst, and the regenerated gas (RG) produced is supplied as a complementary fuel to a combustion device (COMB) mounted upstream of the generator (1) and/or is used otherwise in a chemico-energetic manner.

Object of the invention is a regenerator of combustion gases with an exhaust gas catalytic converter.

It is known from DE 34 13 419 A1 to install an exhaust gas catalytic converter in the exhaust gas recirculation pipe of a combustion power engine, so that its reclaim gas is additionally injected into the intake duct.

Furthermore a device for the catalytic reformation of fuel with water to hydrogen is known from DE 100 19 007 A1, whereat the hydrogen is generated by a catalyst and, by means of a membrane, is separated from the other gases. In that process the reforming catalytic converter is heated by the exhausts of a combustion power engine, to which the hydrogen is additionally fed.

Furthermore it is known to run combustion exhaust gases of an air/hydrocarbon operated combustion unit, particularly those of a combustion power engine, through a catalysing device, where unburnt hydrocarbon fuel and combustion intermediates, such as NOₓ, are gradually transformed to environmentally compatible exhaust products, such as CO₂, H₂O vapour and N₂, by catalytic treatment. The temperature in the catalytic converter during the process of that treatment is approximately 1,000° C., and the pressure in its casing is normally of several bar, due to the back pressure of the downstream silencer. The standard catalytic converters consist of a narrow, large surface, lamellated support structure, thinly coated with a platinum metal or metal mix as active catalyst substance. The stoichiometrically balanced composition of the air/fuel supply is provided by a control device, governed by the readings of an exhaust gas probe, which detects the concentration of NOₓ. In the catalytic converter, the thermal and chemical energy contained in the exhaust gas is uselessly released as heat.

Furthermore it is known to branch off a part of the hot exhaust gases and to add them to the combustion air, whereby a part of the energy, contained in the exhaust gas, is profitably utilised in the following combustion. However, the higher charging temperature, increased by the hot combustion gases, results in a lower charging of a combustion engine and, thus, in a decreased maximum power and, in many cases, in an increased generation of NOₓ, which implicates an unwanted energy transfer from the combustion chamber to the catalytic converter.

It is the purpose of the invention to simplify the initially described device and to make better use of the energy contained in the hot combustion gas.

The solution is that the hot operated catalytic converter adjoins to a high temperature resistant diffusion membrane, which again adjoins to a reclaim collector with lower internal pressure than in the catalytic converter, respectively, and that the thus accumulating regenerator gas is fed into a combustion unit, upstream of the regenerator, as additional fuel and/or otherwise used chemo-energetically.

Favourable embodiments are indicated in the secondary claims.

Micro porous open-pored aluminium oxide, also fortified with zirconium oxide, is an established low-priced diffusion-membrane, whereat a pore diameter of 0.5 through 2 μm proved favourable to drain combustible reclaim gas, particularly hydrogen, from the body of the catalytic converter.

Temperature-resistant micro porous membranes of earthy base silicates and/or aluminates, too, such as calcium-aluminium-silicon oxides, have been proved adequate.

It turned out that the generated gas emerges from the membrane at low temperature and that the temperature gradient in the membrane is 1,000° C. and more.

Preferably, a standard motorcar catalytic converter has been used in the test operation. On one side, the membrane was leak proofly attached. Transverse ducts in the catalytic converter block facilitated a lateral leaking of the reclaim gas.

To provide for a preferably steep pressure gradient through the membrane, a baffle plate was installed in the body of the catalytic converter on the output side, to generate an increased backpressure.

To quicken the running up of the catalysing process after intervals, electric glow plugs, as known in diesel engines, and, if need be, an electrically fired flame glow plug, inserted into the catalytic converter's casing and extending into the body of the converter itself, may be useful. Once the catalytic converter has reached its lower working temperature of approximately 900° C., the auxiliary heating is switched off. The catalytic combustion of the NOₓ-parts and the carbon-parts of the hydrocarbons in the combustion gas sustain the working temperature, which can rise to 1,300° C.

The reclaim gas is preferably used as fuel and, for that purpose, injected into the low pressure intake duct of the combustion unit. Thus, the pressure gradient through the membrane is increased, which additionally boosts diffusion of the reclaim gas. A part of the energy contained in the combustion gas thus is reclaimed, in the form of chemical energy of the reclaim gas, from the catalytic converter and utilised. Since the reclaim gas largely consists of cool hydrogen, it does not decrease the charge, if the combustion unit is a combustion engine; moreover, it boosts the combustion because of its high inflammability and good combustibility.

The combustion power engine may be operated without alterations with an upstream connected compressor and a silencer downstream of the catalytic converter. Also, injection of water spray or water vapour for the combustion moderation may be added to the intake duct. The thus increased concentration of water vapour in the combustion gas is preferably split in the catalytic converter, so that additional reclaim gas is created. Alternatively, water spray or water vapour is injected into the catalytic converter to such an amount that the working temperature does not fall below 1,000° C. A heat insulating casing reduces the reactors loss of heat.

Preferably, the diffusion-membrane is made of several rounds of single membranes which are all tied up to a socket made of metal and both are held, sealed and pressed within the mounting plate. The mounting plate consists of multiple high-grade steel plates, batched with intermediate miceous gaskets and, bolted together in flanges, placed with interlaying gaskets between the reclaim collector and the wall of the catalytic converter.

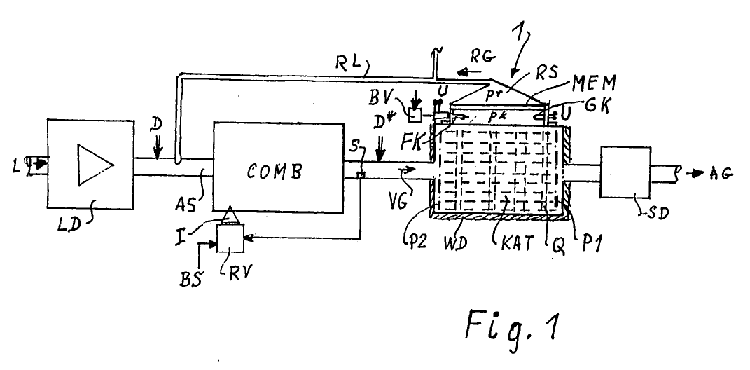

Favourable embodiments are represented in FIGS. 1 to 5.

FIG. 1 shows a block diagram of the regenerator

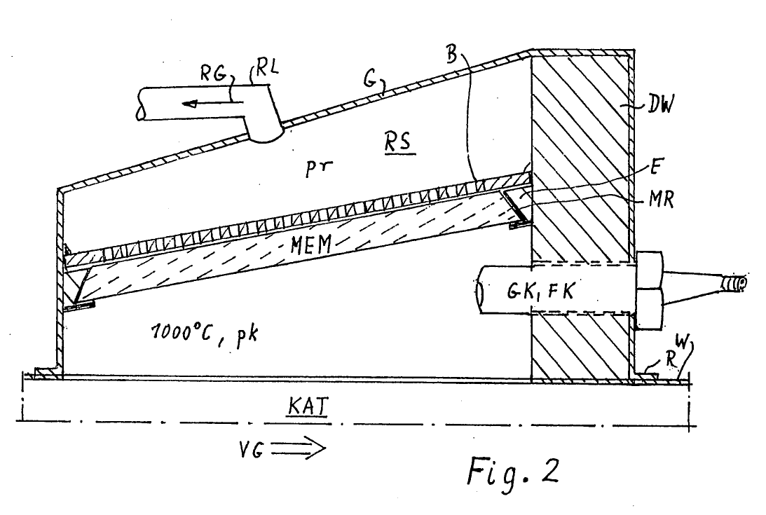

FIG. 2 shows a section with a membrane

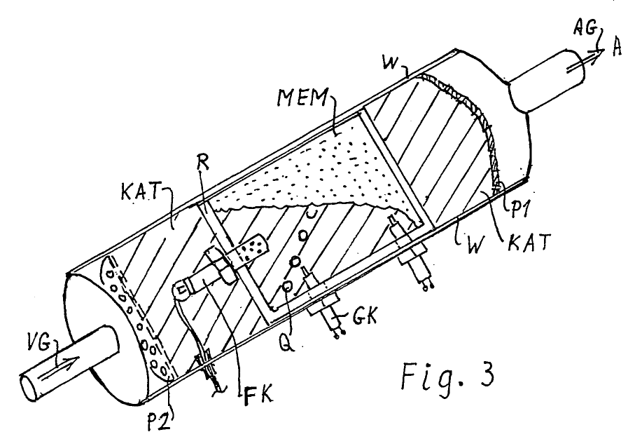

FIG. 3 shows a modified catalytic converter

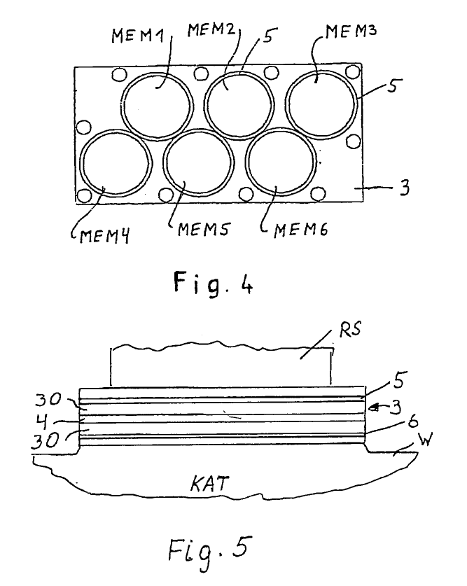

FIG. 4 shows a top view on a single membrane configuration

FIG. 5 shows a lateral view on the membrane installation

The block diagram of FIG. 1 schematically shows the alignment of a regenerator 1 to a catalytic converter KAT of a combustion engine COMB or suchlike, the hot exhaust VG of which is fed into the catalytic converter. After the catalytic treatment, the environmentally compatible exhaust AG leaks from the body of the catalytic converter via the silencer SD, whereat it is piled up by the baffle plate P, so that the internal pressure in the catalytic converter in operation is pk.

In one section, the casing of the catalytic converter is removed and replaced by a membrane MEM of micro porous ceramic matter. On the turned-away side of the catalytic converter, a chamber is designed as reclaim collector, from which the reclaim gas RG is drained.

Preferably, the reclaim gas RG is fed into the intake duct AS of the combustion power engine COMB, into which, if need be, the combustion air L is injected by a charging device LD. The hydrocarbon/fuel BS, e.g. petrol, diesel fuel or propane, is fed as known into the combustion chamber by an injector 1, whereat a control device RV, governed by the signal of a lambda probe S and the demanded engine performance, determines the supply with the optimal fuel/aerial oxygen mixture, so that an environmentally compatible combustion, the catalytic post-combustion included, is accomplished.

On its outside, the catalytic converter is encased in a heat-insulating layer WD to reduce its loss of heat. Lateral drillings Q in the lamellated block of the catalytic converter lead to the membrane side.

Glow plugs GK and/or a flame glow plug FK, additionally supplied with fuel BS, are inserted into the body of the catalytic converter for preheating. The plugs GK, FK are supplied with a voltage U, and the fuel BS is fed in, controlled by a valve BV, during the start-up phase. In the embodiment, the body of the catalytic converter is also upstream equipped with a baffle plate P2, which retains the pressure and the heat of reaction, particularly during the heating up.

Due to the connection with the intake duct AS, the reclaim gas RG is under low pressure, the reclaim pressure pr, so that the diffusion of the reclaim gas is effected by a pressure gradient form the high pressure pk to the low pressure pr through the membrane MEM. The cool reclaim gas RG and the membrane MEM, cooled down by it, also effect a cooling of the membrane mounting and the whole reclaim collector RS. Preferably, the glow plugs and flame glow plugs GK, FK are heat-conductively connected to the membrane mounting E or inserted into the membrane MEM in such a way that they are not damaged by the high internal operating temperature of the catalytic converter KAT.

In a favourable embodiment, water spray or water vapour D in controlled amounts is injected into the combustion unit COMB for the moderation of the combustion temperature and, along with it, the reduction of NOₓ, according to DE 28 43 335, as well as for a substantial reclaim generation in the catalytic converter KAT. In another embodiment, alternatively or additionally water vapour D* is injected in controlled amounts directly into the catalytic converter KAT or immediately into the combustion gases VG upstream of the catalytic converter KAT.

FIG. 2 shows a section of the regenerator. A frame R is welded on the casing of the catalytic converter KAT, to which adjoins a casing G with the reclaim collector RS. Into the one thick-walled side DW of the casing G a glow plug GK is screwed in. From that wall DW extends the membrane MEM of micro porous ceramic matter, framed in a leak proof mounting E, to the other walls of the casing. Thus, a heat-draining connection is established from the glow plug GK through the casing wall DW and the mounting E to the membrane MEM, which is cooled down by diffusion. From the reclaim collector RS leads the reclaim pipe RL to the reclaim load or reclaim storage. Preferably, the membrane MEM is supported by a perforated sheet B and leak proofly framed with a tapered edge MR.

FIG. 3 presents a catalytic converter KAT with the membrane MEM, the flame glow plug FK and glow plugs GK, partially opened and perspectively diagrammed, showing the lateral drillings Q in the body of the catalytic converter.

Moreover, the baffle plates P1, P2, are represented, furnished with narrow apertures, cutting off the body of the catalytic converter upstream and downstream, with only leaving small cracks on both sides.

The reclaim gases, mostly hydrogen, already emerge at 200° C., preferably however, the temperature of the catalytic converter is 1,000° C. to 1,200° C.

The platinum metals commonly used in exhaust catalytic converters, such as palladium or other, possibly may be replaced by base metals, if they are applied in an adequate surface structure on the support. The embossed structure may be of the known combs of metal or ceramic. They provide a surface of, e.g., 20,000 m². In a standard motorcar catalytic converter, a membrane of 100×150×30 mm³ is installed.

FIG. 4 shows the configuration of a diffusion-membrane from multiple single membranes MEM1-MEM6, designed as circular discs and held in a metal socket 2. The sockets 2 are inserted into a mounting plate 3 by a high pressure squeezer, and thus held leak proof even with large temperature differences. Laterally screw joint drillings are represented.

FIG. 5 shows in a lateral view the installation of the assembled membrane. Its mounting plate 3 is bolted with interlaying miceous gaskets 5, 6 between the flange in the casing W of the catalytic converter and a flange of the reclaim collector RS. The mounting plate 3 is composed of layers, whereat between two high-grade steel plates 30, 31 a gasket 4 is sandwiched. Preferably, the gasket 4 consists of high temperature-resistant miceous matter and closes accurately, as the high-grade steel plates, around the sockets.

### REFERENCE LIST

COMB combustion unit
KAT catalytic converter
L air
BS fuel
I injector
LD charging device
AG exhaust
MEM diffusion-membrane
RG reclaim gas
RS reclaim collector
Q lateral ducts
P1, P2 baffle plates
VG combustion gases
AS intake duct
FK flame glow plug
BV fuel valve
U electric plug socket
GK glow plug
S lambda probe
RV control device
1 regenerator
pr reclaim pressure
pk internal pressure of catalytic converter
SD silencer
WD heat insulating
RL reclaim pipe
R frame
G casing
E mounting
DW casing wall
D, D* vapour
B perforated sheet
MR tapered edge
W wall of the catalytic converter
2 socket
mounting plate
high-grade steel plates
high-grade steel plates
gasket
miceous gasket
miceous gasket
1 single membrane
2 single membrane

1. Regenerator of combustion exhaust gases (VG) with an exhaust gas catalytic converter (KAT), characterised by the fact that the hot operated catalytic converter (KAT) adjoins to a high temperature resistant diffusion-membrane (MEM), which, then again, adjoins to a reclaim collector (RS) with less internal pressure (pr) than the pressure (pk) in the catalytic converter, respectively, and that the thus accumulating reclaim gas (RG) is fed into a combustion unit (COMB), upstream of the regenerator, as additional fuel, and/or to be used otherwise chemo energetically.

2. Regenerator according to claim 1, characterised by the fact that the diffusion membrane (MEM) consists of a high temperature-resistant micro porous open pored ceramic.

3. Regenerator according to claim 2, characterised by the fact that the membrane (MEM) consists of earthy base aluminates and or silicates.

4. Regenerator according to claim 2, characterised by the fact that the membrane (MEM) consists of aluminium oxides and/or zirconium oxides.

5. Regenerator according to claim 1, characterised by the fact that the membrane (MEM) is held in a fitting mounting (E) in a casing (G) that is welded with a frame R on one of the walls (W) of the catalytic converter (KAT).

6. Regenerator according to claim 5, characterised by the fact that the membrane (MEM) features an edge (R), tapering in the direction of the pressure gradient (pk, pr).

7. Regenerator according to claim 1, characterised by the fact that the membrane (MEM) on the side of the reclaim collector (RS) is supported by a perforated sheet (B).

8. Regenerator according to claim 7, characterised by the fact that at least one electric glow plug (GK) and/or fuel-supplied flame glow plug is/are inserted in the wall (W) or the thick-walled side (DW) or the frame (R) for the heating of the catalytic converter.

9. Regenerator according to claim 1, characterised by the fact that the catalytic converter (KAT) is equipped upstream and downstream with one baffle plate (P1, P2), respectively.

10. Regenerator according to claim 1, characterised by the fact that the catalytic converter (KAT) contains at least one lamellated block, coated with a catalyst metal, which is perforated by lateral ducts (Q) that end near to the membrane (MEM).

11. Regenerator according to claim 1, characterised by the fact that the catalytic converter (KAT) is encased in an insulating layer (WD).

12. Regenerator according to claims 1, characterised by the fact that the combustion unit (COMB) is supplied with air (L) and a hydrocarbon fuel (BS) by a control device (RV), which is connected with a lambda probe (S) upstream to the catalytic converter (KAT).

13. Regenerator according to claim 12, characterised by the fact that water spray or water vapour (D, D*) is injected in controlled amounts directly into the combustion unit (COMB) or the catalytic converter (KAT).

14. Regenerator according to claim 1, characterised by the fact that the combustion unit (COMB) is a combustion power engine.

15. Regenerator according to claim 14, characterised by the fact that an air charging device is connected upstream to the combustion power engine (COMB).

16. Regenerator according to claim 14, characterised by the fact that a silencer (SD) is connected downstream to the catalytic converter (KAT).

17. Regenerator according to claim 14, characterised by the fact that the reclaim gas (RG) is fed into an intake duct (AS) of the combustion power engine (COMB) via a reclaim pipe (RL).

18. Regenerator according to claim 1 characterised by the fact that the diffusion membrane (MEM) consists of multiple circular single membranes, each of them framed in a high temperature resistant metal socket (2) and inserted leak proofly into a mounting plate (3).

19. Regenerator according to claim 18, characterised by the fact that the mounting plate (3) consists of at least two high-grade steel plates (30, 31) with interlaying gaskets (4), and that sockets 2 by high pressure squeezing are inserted into the mounting plate (3).

20. Regenerator according to claim 19, characterised by the fact that the gaskets (4) consist of a miceous sealing matter, and the mounting plate (3) is bolted with interlaying miceous gaskets (5, 6) between one wall (W) of the catalytic converter (KAT) and the reclaim collector (RS).
